(19) United States
(12) Patent Application Publication
(10) Pub. No.: US 2026/0024073 A1
(43) Pub. Date: Jan. 22, 2026

(54) SYSTEMS AND METHODS FOR MOBILE DATA TRANSMISSIONS TO REMOTE DATA CENTERS USING NEAR FIELD COMMUNICATION

(71) Applicant: BANK OF AMERICA CORPORATION, CHARLOTTE, NC (US)

(72) Inventors: Joseph Benjamin Castinado, North Glenn, CO (US); Harold F. Carmody, Charlotte, NC (US); Shailesh Lolam, Glendale, AZ (US); Ian C. Bitler, Middletown, DE (US)

(73) Assignee: BANK OF AMERICA CORPORATION, CHARLOTTE, NC (US)

(21) Appl. No.: 18/776,739

(22) Filed: Jul. 18, 2024

(51) Int. Cl. G06Q 20/32; G06Q 20/02

(52) U.S. Cl. CPC G06Q 20/3278; G06Q 20/02; G06Q 2220/00

(57) ABSTRACT

Systems, computer program products, and methods are described herein for mobile data transmissions to remote data centers using near field communication. The present disclosure is configured to include a processing device and a non-transitory storage device containing instructions which, when executed by the processing device, cause the processing device to perform the steps of: initiating a transaction on an NFC-enabled mobile device, prompting a user to choose a transaction method, instructing the user to tap or hold a resource transmission instrument to initiate secure data exchange, creating a secure sandbox environment for the transaction, detecting and capturing payment data within the sandbox, encrypting the payment data, transmitting the encrypted data to a third-party processor, receiving an approval response, notifying the user of the completed transaction, deleting the sandbox environment upon transaction completion, and logging transaction details for record-keeping and compliance.

### TECHNOLOGICAL FIELD

Example embodiments of the present disclosure relate to mobile data transmissions to remote data centers using near field communication.

### BACKGROUND

With the proliferation of online transactions, the security of customer information, including credit and debit card details, has become a significant concern. Malfeasant users continuously attempt to breach or obtain sensitive customer information stored in data stores with online merchants. This situation poses problems not only to customers but also to merchants, who bear the responsibility of maintaining stringent security measures to protect this data. Additionally, the process of manually entering card information is both time-consuming and prone to errors, particularly on smaller screens such as those on mobile devices. This dual challenge of ensuring both security and convenience in online transactions limits the overall effectiveness and user experience of digital commerce.

Applicant has identified a number of deficiencies and problems associated with mobile data transmissions to remote data centers using near field communication. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for mobile data transmissions to remote data centers using near field communication. The invention provides a secure and convenient system for transmitting resource information, such as credit or debit card details, using Near Field Communication (NFC) technology within mobile applications and web browsers. When a transaction is initiated, users can transmit their resource information by tapping their NFC-enabled resource transmission instrument (e.g., a credit card) on their mobile device. This system generates a secure “sandbox” for each transaction, ensuring that the resource data is communicated securely to the resource provider without being exposed to the recipient. The resource provider issues a one-time key for the transaction, which is transmitted to the recipient account to indicate transaction completion, all while keeping the resource data secure. The sandbox is destroyed upon completion of the transaction, providing an additional layer of security.

For devices not equipped with NFC, the system employs alternative security measures, such as geolocation verification and the registration of historical transaction data. It verifies the device's location and consistency with previous transaction locations before requesting confirmation that the resource transmission instrument is physically present. This may involve using the device's camera to take a picture of the instrument. This ensures that the resource instrument is physically present with the user, and the resource data is never transmitted over a network or stored on a recipient's system.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for mobile data transmissions to remote data centers using near field communication, in accordance with an embodiment of the disclosure;

FIG. 2 illustrates a process flow 200 for mobile data transmissions to remote data centers using Near Field Communication (NFC), in accordance with an embodiment of the disclosure; and

FIG. 3 illustrates a process flow for mobile data transmissions to remote data centers using near field communication, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

As used herein, “Near Field Communication (NFC)” refers to a set of communication protocols that enable two electronic devices, typically a mobile device and another device such as a payment terminal, to establish communication by bringing them within close proximity, generally within a few centimeters. NFC technology allows for the exchange of data between devices through electromagnetic fields, facilitating secure transactions, data transfer, and access to digital content. The NFC-enabled device may initiate and conduct transactions by interacting with an NFC tag or another NFC-enabled device, ensuring a quick and seamless communication process.

As used herein, “Geolocation Verification” refers to the process of confirming the geographic location of a device to ensure its authenticity and legitimacy during a transaction. This involves utilizing the device's GPS capabilities or triangulating its position based on Wi-Fi signals, cell towers, or other network-based location services. Geolocation verification ensures that the device is in a recognized and expected location, providing an additional layer of security by preventing unauthorized transactions from unfamiliar locations. This verification process may include cross-referencing historical location data to detect any anomalies.

As used herein, a “Resource Transmission Instrument” refers to any device or object used to transmit resource information during a transaction. This includes, but is not limited to, credit cards, debit cards, electronic payment vehicles, and other similar instruments that store and transmit resource data. The resource transmission instrument interacts with NFC-enabled devices or other secure transmission methods to facilitate transactions without exposing sensitive information. The instrument may be physical, such as a card with an embedded chip, or digital, such as a virtual card stored in a digital wallet.

As used herein, a “Sandbox” refers to a secure and isolated environment used to execute transactions or processes without exposing sensitive information. In the context of the present disclosure, a sandbox is dynamically created during a transaction to securely handle resource data transmission. This environment isolates the transaction process from the rest of the system, preventing unauthorized access and ensuring that the resource data is used only for the intended transaction. Once the transaction is completed, the sandbox is destroyed, further ensuring that no residual data is left behind that could be utilized.

As used herein, a “One-time Key” refers to a unique and temporary key generated for a single transaction to enhance security. This key is issued by a resource provider and is used to authenticate and complete the transaction without revealing the underlying resource data. The one-time key is valid only for the specific transaction it was generated for, and it becomes invalid once the transaction is completed. This approach minimizes the problem of key reuse and reduces the potential for bad activities by ensuring that each transaction is uniquely authenticated.

As used herein, a “Resource Provider” refers to an entity or system that issues a one-time key and facilitates the secure transmission of resource information during a transaction. The resource provider may be a financial institution, payment gateway, or any other entity responsible for managing and securing the resource data. The resource provider's role includes generating the one-time key, verifying the authenticity of the transaction, and ensuring that the resource data is transmitted securely to the recipient account without exposure.

As used herein, a “Recipient Account” refers to the account that receives the resource transmission information during a transaction. This account could belong to a merchant, service provider, or any other entity receiving the payment or resource. The recipient account is designated to receive the authenticated transaction details, which include the one-time key issued by the resource provider. The recipient account processes the transaction without having access to the sensitive resource data, thereby maintaining the security and privacy of the resource information.

As used herein, a “Non-NFC Enabled Device” refers to a device that does not have Near Field Communication capabilities. Examples of non-NFC enabled devices include certain models of laptops, desktops, tablets, and older mobile phones that lack the hardware or software required to facilitate NFC-based transactions. For such devices, alternative methods of secure data transmission and verification, such as geolocation verification and additional authentication steps, are employed to ensure the security and integrity of the transaction.

The present disclosure introduces a novel technology for secure and efficient resource transmission using Near Field Communication (NFC) and geolocation verification. This technology is designed to protect sensitive resource information, such as credit or debit card details, during online transactions.

The problem in the field of online transactions involves the secure storage and transmission of sensitive customer information. Traditional methods of storing card information in merchant databases expose this data to potential breaches. Additionally, manually entering card details is time-consuming and prone to errors, especially on mobile devices. These issues compromise both the convenience and security of online transactions.

The solution provided by this technology leverages NFC and geolocation verification to secure resource transmissions. By tapping an NFC-enabled resource transmission instrument on a mobile device, users can securely transmit their resource information. The system creates a secure sandbox for each transaction, preventing exposure of sensitive data. For non-NFC devices, geolocation verification and historical transaction data are used to ensure the legitimacy of transactions. This ensures that sensitive information is never stored on recipient systems, maintaining both convenience and security.

Accordingly, the present disclosure provides a secure and convenient system for transmitting resource information using NFC and geolocation verification. It eliminates the need to store sensitive data on merchant systems, reduces the time and effort required to enter card details manually, and ensures that sensitive information is transmitted securely. The system creates a secure sandbox for each transaction, generates a one-time key for each transaction, and destroys the sandbox upon completion, maintaining the integrity and confidentiality of the resource information.

What is more, the present disclosure provides a technical solution to a technical problem. As described herein, the technical problem includes the secure transmission and storage of sensitive resource information during online transactions. The technical solution presented herein allows for the secure and efficient transmission of resource data using NFC and geolocation verification. In particular, the use of NFC to create a secure sandbox for each transaction and the application of geolocation verification for non-NFC devices improve the security and convenience of online transactions. This solution is an improvement over existing methods by reducing the number of steps required to secure transactions, thereby conserving computing resources such as processing power, storage, and network bandwidth. It also reduces the potential for errors and the need for manual input, enhancing the overall efficiency and speed of transactions. Furthermore, by determining the optimal amount of resources needed for each transaction, the solution minimizes network traffic and load on computing systems. The technical solution described herein employs a rigorous, computerized process to perform tasks that were previously done manually, thus conserving resources and improving the overall transaction process.

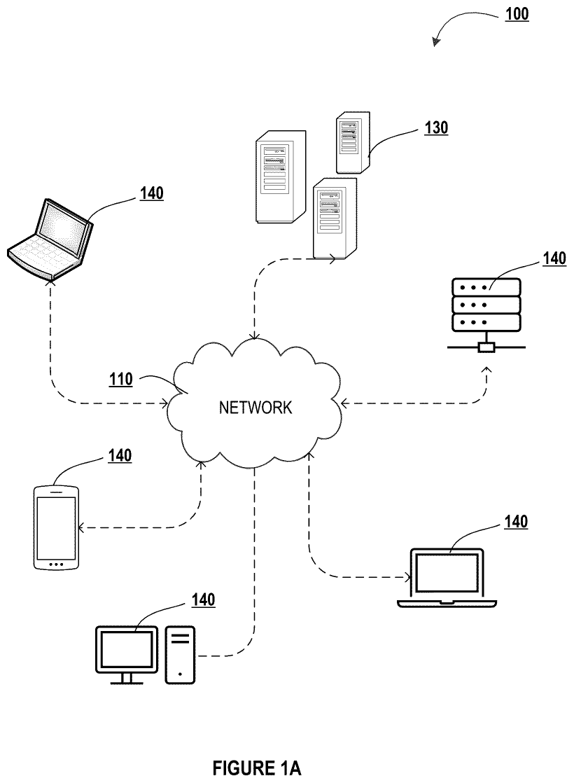

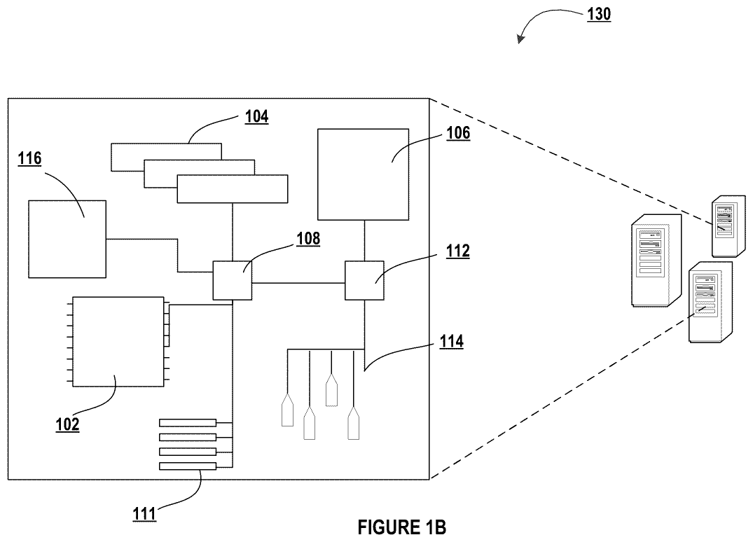

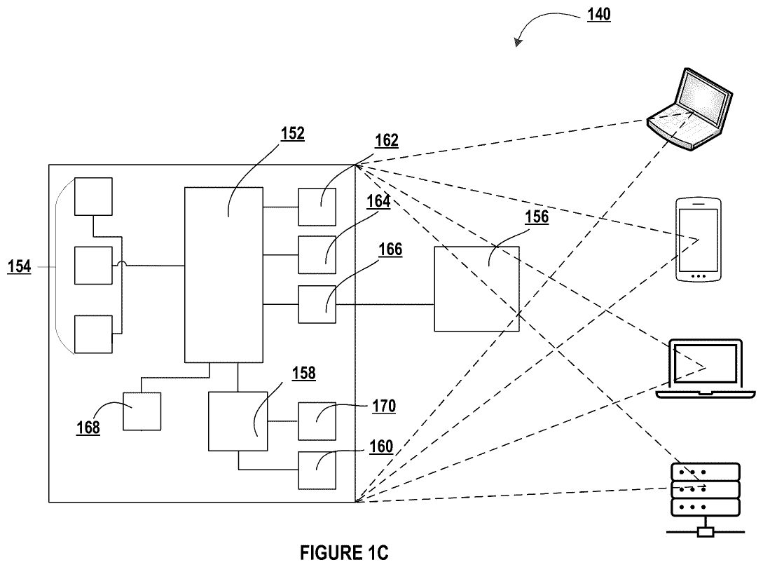

FIGS. 1A-1C illustrate technical components of an exemplary distributed computing environment 100 for mobile data transmissions to remote data centers using near field communication, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

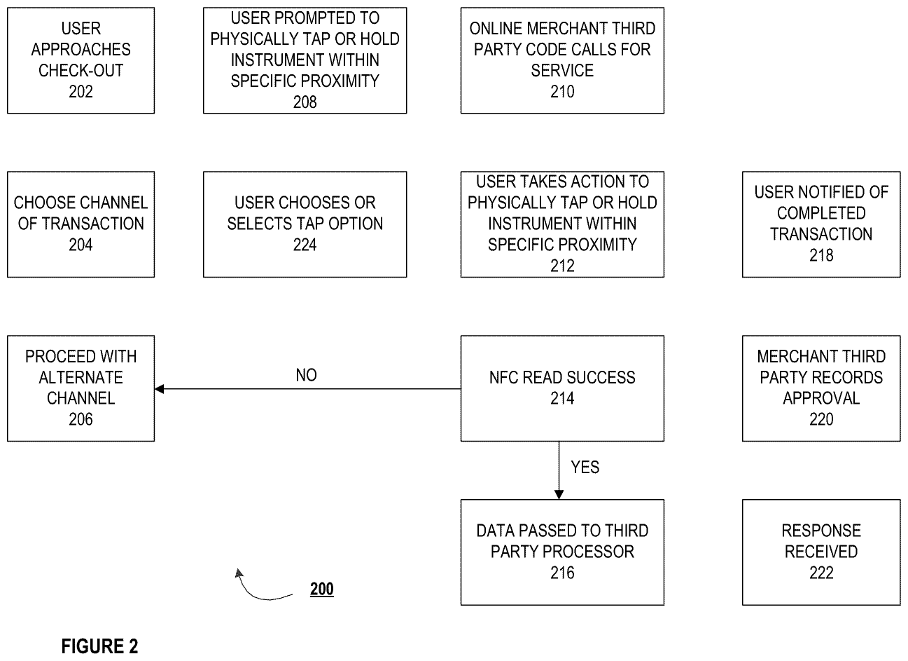

FIG. 2 illustrates a process flow 200 for mobile data transmissions to remote data centers using Near Field Communication (NFC), in accordance with an embodiment of the disclosure. As shown by block 202, the user approaches the check-out process on an NFC-enabled device, such as a smartphone or tablet. The user's device runs a mobile application or web browser that supports NFC transactions. At this point, the user has selected items for purchase and is ready to initiate the payment process. The mobile application or web browser is designed to interface with the NFC hardware embedded in the device, typically utilizing APIs provided by the operating system (e.g., Android's NFC API or iOS Core NFC).

Moving to block 204, the system prompts the user to choose the channel of the transaction. The user can select either the traditional manual entry method or opt for the NFC-enabled transaction. This choice is presented through the user interface of the mobile application or web browser, typically implemented using HTML5, CSS, and JavaScript for web-based solutions, or native code for mobile applications such as Swift for iOS and Kotlin for Android. The user interface may include buttons or prompts that guide the user through the selection process, ensuring an intuitive and seamless user experience.

If the user chooses the NFC-enabled transaction, as indicated in block 224, the system proceeds to block 208. Here, the user is prompted to physically tap or hold their resource transmission instrument, such as a credit card or NFC-enabled device, within a specific proximity of the mobile device. The proximity required for NFC communication is typically within a few centimeters, ensuring secure data transmission. The prompt is generated by the mobile application or web browser, which instructs the user to position the instrument close enough to the device's NFC reader to initiate the communication.

In block 212, the user takes the action to physically tap or hold the resource transmission instrument near the NFC reader of the mobile device. The NFC reader, which is part of the device's hardware, detects the presence of the instrument and initiates the secure data exchange process. This interaction is facilitated by NFC communication protocols defined by standards such as ISO/IEC 14443. When the instrument is in range, the NFC reader generates a magnetic field that powers the NFC chip in the resource transmission instrument, allowing it to transmit data back to the reader.

The system then checks if the NFC read is successful, as shown in block 214. If the NFC reader successfully captures the data from the resource transmission instrument, the process moves to block 216. If the read is unsuccessful, the system prompts the user to proceed with an alternate transaction channel, as indicated in block 206, which may involve manually entering payment details. The success of the NFC read is determined by the ability of the NFC reader to decode the data transmitted from the instrument and verify its integrity.

In block 216, the captured data is securely passed to a third-party processor. This data transmission is typically encrypted using protocols such as TLS (Transport Layer Security) to ensure confidentiality and integrity. The third-party processor, which could be a payment gateway or financial institution, receives the data and begins processing the transaction. The third-party processor's system is designed to handle encrypted data, decrypt it, and perform the necessary checks to validate the transaction.

The third-party processor communicates with the online merchant's system, as indicated in block 210, to validate the transaction. This step involves verifying the user's account details, checking for available funds, and ensuring that the transaction adheres to security and issue prevention measures. The merchant system is often implemented using server-side technologies like Node.js, Python, or Java, along with database systems such as SQL or NoSQL databases. The communication between the third-party processor and the merchant system is also secured using encryption to prevent any data breaches.

Once the transaction is approved, the third-party processor sends an approval response back to the system, as shown in block 222. This response includes a confirmation that the payment has been successfully processed. The system then notifies the user of the completed transaction in block 218, typically through a user interface update or a push notification. The notification mechanism may utilize frameworks such as Firebase Cloud Messaging (FCM) or Apple Push Notification Service (APNS) to ensure real-time updates.

Finally, the merchant's system records the transaction approval, as indicated in block 220. This record-keeping is essential for transaction tracking, accounting, and future reference. The merchant system logs the transaction details in its database, ensuring that all necessary information is stored securely for compliance and audit purposes. The database may employ encryption and other security measures to protect the stored data from unauthorized access. This process flow ensures that the transaction is completed securely and efficiently, leveraging the capabilities of NFC technology and robust encryption protocols.

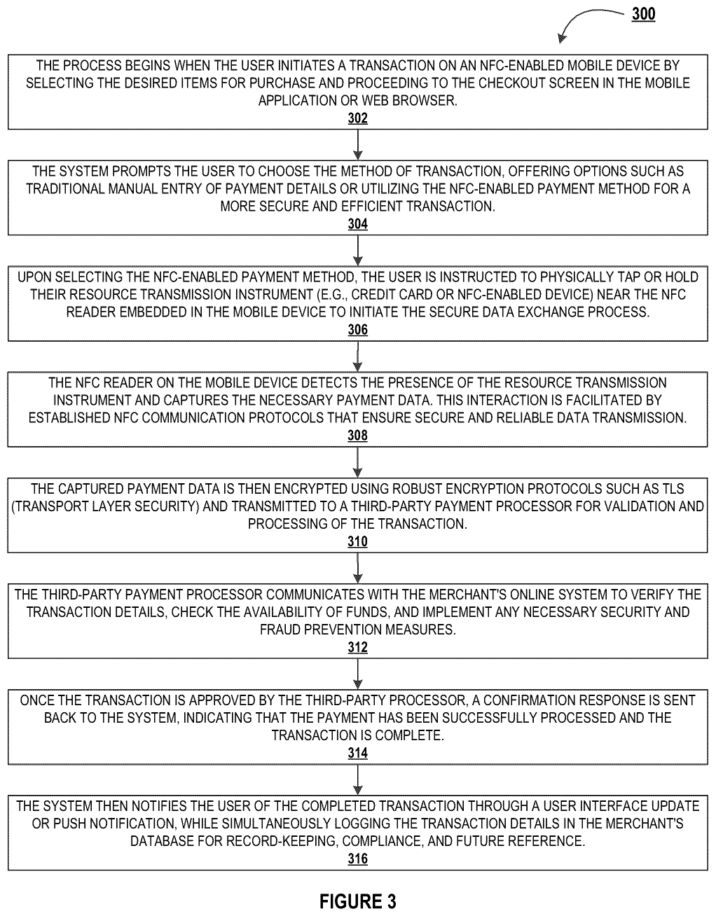

FIG. 3 illustrates a process flow 300 for mobile data transmissions to remote data centers using near field communication, in accordance with an embodiment of the disclosure. As shown in block 302, the process begins when the user initiates a transaction on an NFC-enabled mobile device by selecting the desired items for purchase and proceeding to the checkout screen in the mobile application or web browser. This step involves the user finalizing their shopping and moving to the payment phase within the application interface.

In block 304, the system prompts the user to choose the method of transaction. The user is given the option to select either the traditional manual entry method for inputting payment details or to utilize the NFC-enabled payment method for a more secure and efficient transaction. This choice is presented through the user interface of the mobile application or web browser, which could be implemented using technologies such as HTML5, CSS, and JavaScript for web-based interfaces, or native code like Swift for iOS and Kotlin for Android applications.

Upon selecting the NFC-enabled payment method, as indicated in block 224, the system proceeds to block 306. At this stage, the user is instructed to physically tap or hold their resource transmission instrument, such as a credit card or NFC-enabled device, within a specific proximity of the mobile device. The required proximity for NFC communication is typically within a few centimeters, ensuring that the data transmission is secure and only occurs when the devices are very close to each other.

As depicted in block 308, the user then takes action to physically tap or hold the resource transmission instrument near the NFC reader of the mobile device. The NFC reader, which is part of the device's hardware, detects the presence of the instrument and initiates the secure data exchange process. This interaction is facilitated by NFC communication protocols defined by standards such as ISO/IEC 14443, ensuring that the data transfer is secure and reliable.

In block 310, the captured payment data is then encrypted using robust encryption protocols such as TLS (Transport Layer Security). This encrypted data is transmitted to a third-party payment processor for validation and processing of the transaction. The encryption ensures that the data remains confidential and integral during transmission, protecting it from potential interception or tampering.

Block 312 illustrates that the third-party payment processor communicates with the merchant's online system to verify the transaction details, check the availability of funds, and implement any necessary security and issue prevention measures. This step ensures that the transaction is legitimate and that the user has requisite funds to complete the purchase. The merchant system may utilize server-side technologies like Node.js, Python, or Java, and database systems such as SQL or NoSQL databases to manage and verify the transaction data.

Once the transaction is approved by the third-party processor, as shown in block 314, a confirmation response is sent back to the system. This response includes confirmation that the payment has been successfully processed, indicating the transaction is complete. The system receives this confirmation and prepares to notify the user of the successful transaction.

Finally, in block 316, the system notifies the user of the completed transaction through a user interface update or push notification. This notification is typically implemented using frameworks such as Firebase Cloud Messaging (FCM) or Apple Push Notification Service (APNS) to ensure real-time updates. Simultaneously, the merchant's system logs the transaction details in its database for record-keeping, compliance, and future reference. The database may employ encryption and other security measures to protect the stored data from unauthorized access.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for mobile data transmissions to remote data centers using near field communication, the system comprising:
a processing device;
a non-transitory storage device containing instructions when executed by the processing device, causes the processing device to perform the steps of:
initiating a transaction on a mobile device;
prompting a user to choose a method of transaction via the mobile device, wherein the user can select between manual entry of instrument details or a near field communication (NFC) enabled method;
creating a secure virtual sandbox environment for the transaction;
upon selection of the NFC enabled method, instructing the user via the mobile device to physically tap or hold a resource transmission instrument within proximity of the mobile device to initiate a secure data exchange;
detecting presence of the resource transmission instrument using an NFC reader embedded in the mobile device and capturing data;
encrypting the captured data using a secure encryption protocol;
transmitting the encrypted data to a third-party processor for validation and processing;
receiving an approval response from the third-party processor indicating that the transaction is complete;
notifying the user of a completed transaction;
deleting the virtual sandbox environment upon completion of the transaction to ensure no residual data remains; and
logging transaction details in a merchant's database for record-keeping and compliance.

2. The system of claim 1, wherein the instructions further cause the processing device to verify the user's geolocation and compare it to historical transaction data before initiating the NFC-enabled payment method.

3. The system of claim 1, wherein the NFC reader complies with ISO/IEC 14443 standards for secure data transmission.

4. The system of claim 1, wherein the encryption protocol used to encrypt the captured payment data is Transport Layer Security (TLS).

5. The system of claim 1, wherein the third-party payment processor communicates with the merchant's online system to verify transaction details, check availability of funds, and implement security and issue prevention measures.

6. The system of claim 1, wherein the user is notified of the completed transaction through a user interface update or a push notification to the mobile device.

7. The system of claim 1, wherein the system is further configured to: prompt the user to proceed with an alternate transaction channel if the NFC read is unsuccessful.

8. A computer program product for mobile data transmissions to remote data centers using near field communication, the computer program product comprising a non-transitory computer-readable medium comprising code causing an apparatus to perform the following steps:
initiating a transaction on a mobile device;
prompting a user to choose a method of transaction via the mobile device, wherein the user can select between manual entry of instrument details or a near field communication (NFC) enabled method;
creating a secure virtual sandbox environment for the transaction;
upon selection of the NFC enabled method, instructing the user via the mobile device to physically tap or hold a resource transmission instrument within proximity of the mobile device to initiate a secure data exchange;
detecting presence of the resource transmission instrument using an NFC reader embedded in the mobile device and capturing data;
encrypting the captured data using a secure encryption protocol;
transmitting the encrypted data to a third-party processor for validation and processing;
receiving an approval response from the third-party processor indicating that the transaction is complete;
notifying the user of a completed transaction;
deleting the virtual sandbox environment upon completion of the transaction to ensure no residual data remains; and
logging transaction details in a merchant's database for record-keeping and compliance.

9. The computer program product of claim 8, wherein the instructions further cause the processing device to verify the user's geolocation and compare it to historical transaction data before initiating the NFC-enabled payment method.

10. The computer program product of claim 8, wherein the NFC reader complies with ISO/IEC 14443 standards for secure data transmission.

11. The computer program product of claim 8, wherein the encryption protocol used to encrypt the captured payment data is Transport Layer Security (TLS).

12. The computer program product of claim 8, wherein the third-party payment processor communicates with the merchant's online system to verify transaction details, check availability of funds, and implement security and issue prevention measures.

13. The computer program product of claim 8, wherein the user is notified of the completed transaction through a user interface update or a push notification to the mobile device.

14. The computer program product of claim 8, further configured to: prompt the user to proceed with an alternate transaction channel if the NFC read is unsuccessful.

15. A method for mobile data transmissions to remote data centers using near field communication, the method comprising:
initiating a transaction on a mobile device;
prompting a user to choose a method of transaction via the mobile device, wherein the user can select between manual entry of instrument details or a near field communication (NFC) enabled method;
creating a secure virtual sandbox environment for the transaction;
upon selection of the NFC enabled method, instructing the user via the mobile device to physically tap or hold a resource transmission instrument within proximity of the mobile device to initiate a secure data exchange;
detecting presence of the resource transmission instrument using an NFC reader embedded in the mobile device and capturing data;
encrypting the captured data using a secure encryption protocol;
transmitting the encrypted data to a third-party processor for validation and processing;
receiving an approval response from the third-party processor indicating that the transaction is complete;
notifying the user of a completed transaction;
deleting the virtual sandbox environment upon completion of the transaction to ensure no residual data remains; and
logging transaction details in a merchant's database for record-keeping and compliance.

16. The method of claim 15, wherein the instructions further cause the processing device to verify the user's geolocation and compare it to historical transaction data before initiating the NFC-enabled payment method.

17. The method of claim 15, wherein the NFC reader complies with ISO/IEC 14443 standards for secure data transmission.

18. The method of claim 15, wherein the encryption protocol used to encrypt the captured payment data is Transport Layer Security (TLS).

19. The method of claim 15, wherein the third-party payment processor communicates with the merchant's online system to verify transaction details, check availability of funds, and implement security and issue prevention measures.

20. The method of claim 15, wherein the system is further configured to: prompt the user to proceed with an alternate transaction channel if the NFC read is unsuccessful.
